(19) United States
(12) Patent Application Publication
(10) Pub. No.: US 2012/0066968 A1
(43) Pub. Date: Mar. 22, 2012

(54) System and Method for Manufacturing Various Waste and Municipal Solid Waste for Producing a Solid Fuel

(76) Inventors: William F. Rhatigan, Pocasset, MA (US); Gerard J. O'Brien, Pocasset, MA (US)

(21) Appl. No.: 13/090,356

(22) Filed: Apr. 20, 2011

Related U.S. Application Data
(60) Provisional application No. 61/325,941, filed on Apr. 20, 2010.

(51) Int. Cl. C10L 5/00; B30B 11/00

(52) U.S. Cl. 44/605; 44/635

(57) ABSTRACT

The present invention generally relates to waste to energy systems and methods. The instant invention is further directed to processes and systems for mixing, binding, and stabilizing agents for manufactured refuse driven solid fuel.

### FIELD OF THE INVENTION

The present invention generally relates to energy gasification and combustion systems and methods. The instant invention is further directed to systems and methods for making solid fuels from various waste compositions.

### BACKGROUND OF THE INVENTION

Large quantities of solid waste, construction debris, large items, and low value hazardous waste are generated daily in urban, suburban, and rural areas. Additionally, industrial, manufacturing, and agricultural businesses generate solid waste in vast quantities. Even with recycling efforts and increased awareness, the majority of waste is being hauled and buried in landfills, which within itself creates environmental concerns and problems. It is accordingly desirable to process and manufacture this waste into a viable and renewable manufactured product, such as solid, usable fuel.

Gasification is a proven manufacturing process that converts hydrocarbons in any organic fuel to a synthesis gas (syngas), which can be further processed to produce chemicals, fertilizers, liquid fuels, hydrogen, and electricity. Gasification is a flexible, commercially proven, and efficient technology. Gasification can help improve air quality by reducing Green House Gas emissions as well as emissions of several key air pollutants, depending on the specific feedstock that are employed. These emission reductions provide economic and environmental benefits by virtually eliminating toxic emissions and lowering emission-related operating costs, such as allowance permit costs and emissions-control equipment expenses.

Engineered fuel achieves the reduction of greenhouse gas emission through three separate mechanisms: 1) Generating electrical power or steam by co-firing engineered fuel with coal unique fuel reduces carbon dioxide (CO2) emissions from fossil fuel based electrical generation, 2) Waste-to-energy gasification process effectively avoids all potential methane emissions from landfills; thereby avoiding any potential release of methane in the future and, 3) Recovery of ferrous and nonferrous metals from MSW (Manufactured Solid Waste)) by waste-to-energy is more energy efficient than production from raw materials.

One of the major impediments to large scale success of WTE gasification is the negative implications of MSW on damaging the expensive reactor liner or co-firing in coal systems and the inconsistent resulting gas production. Liners are highly susceptible to both chlorine attack and to local inconsistencies in high temperatures, as well as the MSW, both of which would be found With typical municipal waste systems, and are not likely to last more than a year in service or limit, their use as a feedstock.

This high expense and resultant loss in production revenue can be addressed if the feedstock was consistent and subsequently the BTU and the gases produced were predictable co-firing. The present invention provides solutions to the problems currently associated with WTE combustion or the gasification processes.

### SUMMARY OF THE INVENTION

The instant invention provides systems and methods for making solid fuels from specific waste compositions.

The present invention provides solid fuels that enhance the efficiency and throughputs of energy generation where the fuels are coal, natural gas, syngas, and the process is combustion plasma arc gasification pyrolysis, and pyrolysis gasification.

The present invention provides a system for proper assembly of product materials, a manufacturing process for producing Manufactured Engineered Fuel Feedstock (a solid fuel comprised primarily of any biomass waste, and a binding material and a packaging process that facilitates longer term transportation and storage then these materials will currently allow.

Embodiments of the present invention include a mix of materials and the process of incorporating and packaging these materials to produce a WERC-2 engineered fuel that is an economical and environmental improvement to fuel currently employed in energy generation. The present invention's specific mix of ingredients in the engineered fuel, plus the results of its manufacturing process with recycled binding material, and the rigid packaging materials and design, all are features embodied to contribute to the nation's waste remediation, while dramatically reducing various emission issues resulting from the generation of energy employing raw or separated municipal solid waste or coal as a fuel.

Manufactured solid fuel in accordance with the present invention produces a product that is viable and enhances the efficiency and throughputs of energy generation in the fields of coal, natural gas, syngas, gasification, plasma arc gasification pyrolysis, and pyrolysis gasification. The use of the manufactured solid fuel, co-fired or used exclusively 1 in these methodologies will produce greater throughputs and economic enhancement, while reducing emissions.

### BRIEF DESCRIPTION OF THE DRAWINGS

FIG. 1 is a process flow diagram of the receiving area and the manufacturing area.

FIG. 2 is a diagram of a source of feedstock.

FIG. 3 is a diagram of a system that embodies the present invention.

FIG. 4 is a diagram of a system that embodies the present invention.

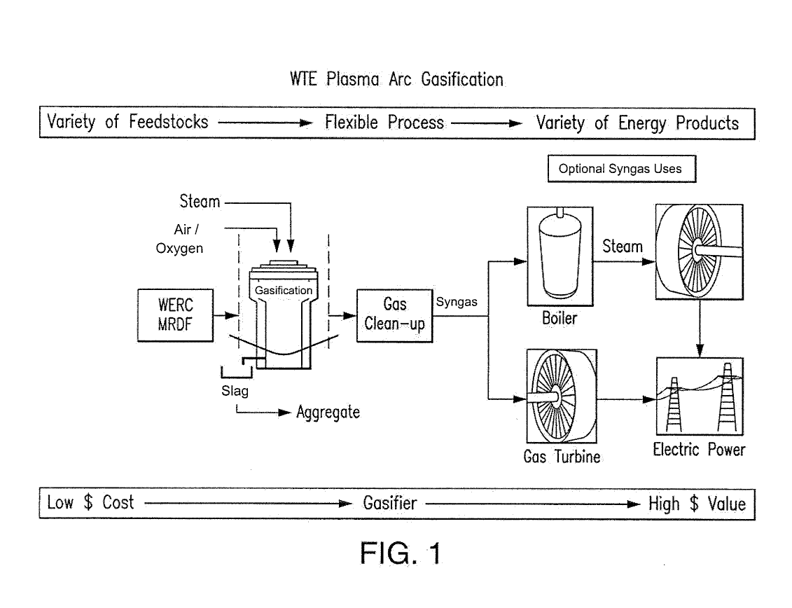

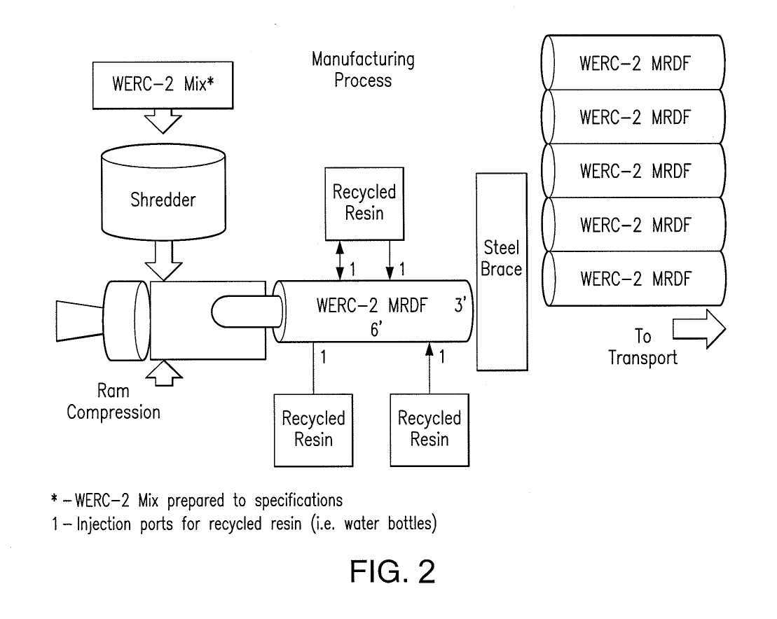

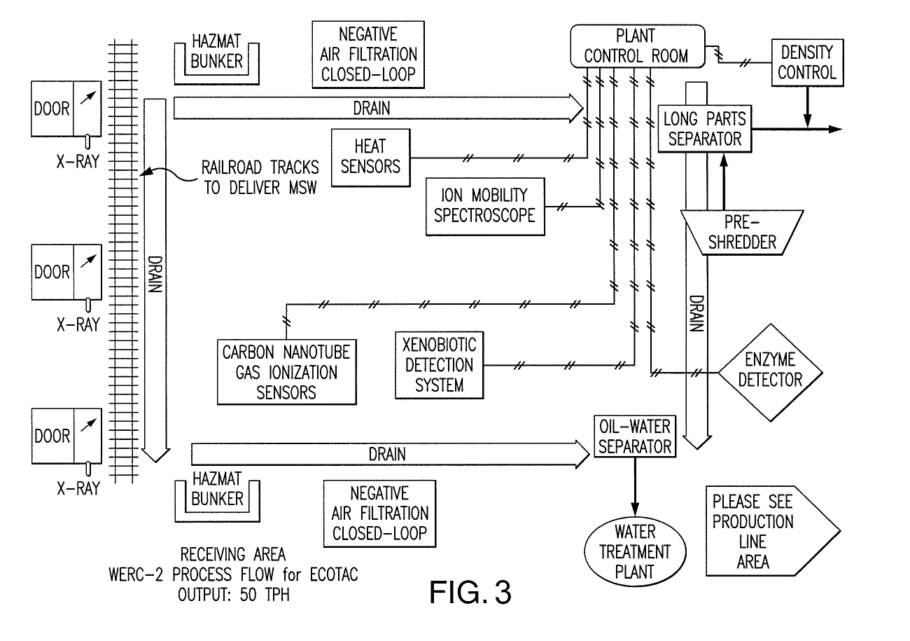

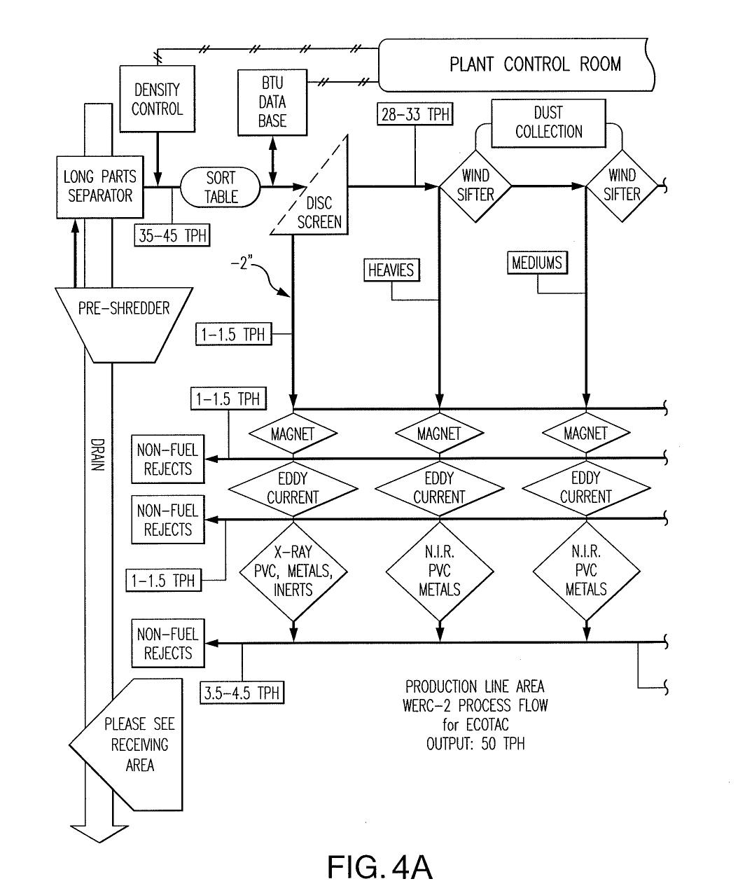

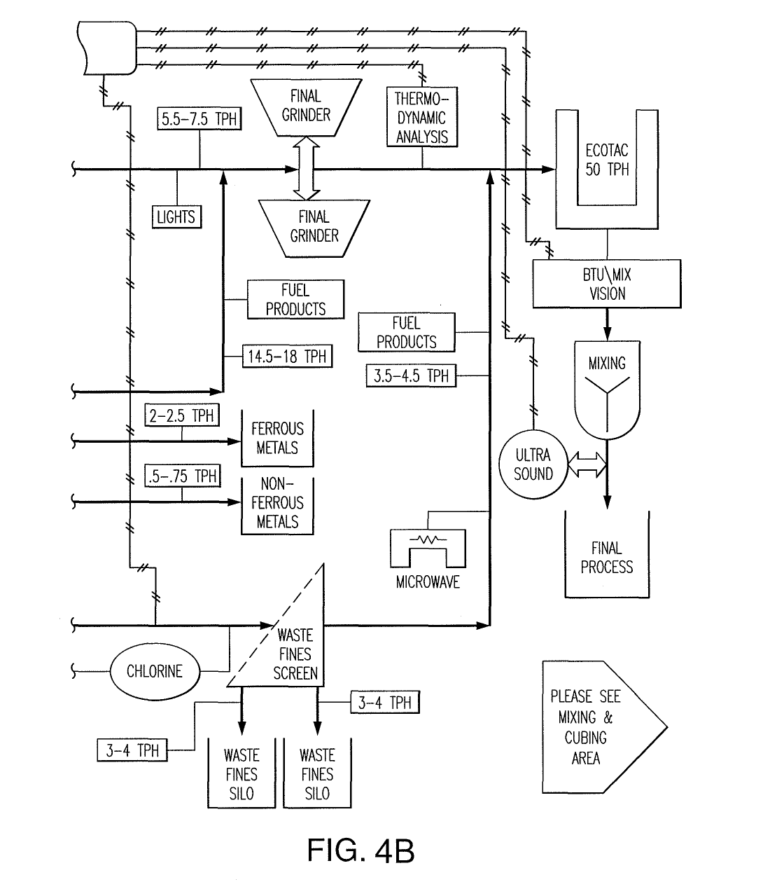

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implicated in other compositions and methods, and that any such variation would be within such modifications that do not part from the scope of the present invention. Before explaining the disclosed embodiments of the present invention in detail, it is also to be understood that the invention is not limited in its application to the details of any particular embodiment shown, since of course the invention is capable of other embodiments. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

The present invention provides a system for proper assembly of product materials, a Manufacturing process for producing an engineered fuel (a solid fuel comprised primarily of any biomass, and waste and a binding material and a packaging process that facilitates longer term transportation and storage then these materials will generally allow. The mixture of materials and the specified process produce a manufactured fuel from the spectrum of existing biomass, and solid waste. At least two portions of the base materials are combined in specific size and ratio to produce the solid fuel that meets the parameters of a specified expectation for BTU, moisture content, and elemental production.

The unique mix of materials and the process of incorporating and packaging these materials produce a WERC-2 Manufactured Engineered Fuel that is an economical and environmental improvement to fuel currently employed in energy generation.

This feedstock formulation and the associated manufacturing process will be critical to the economic success of energy gasification, and combustion operations. This product, designed to be mass manufactured, will guarantee consistent BTU values as specified, with limited moisture content, and predictable elemental outputs. The results are optimum chemical reactions and managed byproducts in gasification, and the combustion processes. The product will produce higher quality syngas, and heat and while less expensive maintenance, and a higher more production output.

The product in accordance with the present invention are composed of common elements of solid waste and specific elements of the RSW (Residential Solid Waste) and recyclable waste. Thermal Energy is consistent and can be production modified to produce specific gas or BTU percentages, and/or specifically limit potentially negative gases or metals and or chemicals, such as chlorine and mercury. -EcoTac products (EcoTac™) products are naturally based carbon and are permeated and encased to produce a solid product designed to withstand the elements to facilitate storage, transportation, and handling. This permits truck, rail, or ship transport without problems of odor, leakage, or rodent attraction. The recycled resin packaging ensures fuel consistency and stability. This permits better inventory management, and capital expenditure reduction normally associated with traditional raw MSW feedstock or various biomass fuels handling and vessel loading.

Reduced feedstock handling costs, the attractive fuel cost, the lowered capital expenditure requirements for combustion plants that employ the engineered fuel, the improved economics of production value are unique characteristics of the feedstocks of the present invention. These characteristics will push the growth of gasification technologies for energy generation as well as sustain and improve the economies and efficiency of various forms of combustion.

Embodiments of the system described herein may have pre-sorting and shredding equipment to segregate usable recycle materials from the process. Such embodiments may also have an additional separator to separate organics from inorganic materials to produce a minimum baseline BTU value.

The pre-shredder will produce a homogenous mix of organics and inorganics, as well as a maximum size of mix being 8″-.

The material will be optically scanned to produce a base line value of the chemical elemental chain of the material to define the BTU value.

Further a system of separation of the organics and inorganics may be added and a grinding process may be added producing some element of the organics or inorganics that are to be added to the product to produce both a constant and variable BTU value.

Sizing of the organics and inorganics is also accomplished through star screening technology. This addition process allows removal of material from the stream of 3″-. Further removal of inerts is completed to prevent a loss of BTU value.

The feedstock is subjected to various removal techniques for removal of ferrous and non-ferrous materials, as well as PVC and heavy metals using x-ray technology and other vision technologies.

Some embodiments of the system may add optical sensors and controllers to assess heat, moisture, particle size, and density of the product. Embodiment of the system may also use a final pulverization to produce a product with a specific BTU value and chemical composition.

Optical sensing in the near infrared spectrum allows for further removal of metals and heavy metals that complicate and compromise the final BTU design.

The system my further comprise a separation unit that is capable of generating a base material that is comprised of the initial BTU value and will produce a certain level of caloric value. The by-products of the separation will be further mixed and ground at varying temperatures and particle size to be produced as a specific additive of the base mixture or solid fuel. This will create a specific consistent BTU value and thermal model for a specific set of compounds of the solid fuel. The factors will affect the burn and gas content of the burnt fuel.

Additionally, desired compounds and additives with varying BTU values, such as organic/inorganic trace chemical elements, may be added to the system and an additional mixer be added to configure the base mix with specific quantities of the additives to produce a solid fuel, with defined limits and offsets for the solid fuel.

Embodiments of the invention also contemplate methods of incorporating through injection and/or mixing of a liquid that has a low viscidity and is capable of being of a higher BTU value than the base mix or to insert certain trace elements, which will change the chemical chain of the gases produced from the burning of the solid fuel.

The present invention may also comprise methods of adding compaction to the system for increasing the weight to volume ratio of the solid fuel. Such compaction may increase the volume of weight issue from the baseline solid fuel, to a density ratio of 6:1 from the baseline ratio.

The addition of compaction to the system may reduce the moisture level of the solid fuel from its baseline level and produce a high BTU level greater than the baseline BTU value. Additionally, the use of compaction can affect the inherent oxygen level

The system may further comprise bailing and packing equipment, configured to encase the solid fuel. This determination will be based on required shelf life, transportability, and the effect of the BTU value of the baseline or modified fuel. The system of bailing and/or packing will be used to prevent denigration of the initial BTU value and chemical elements. Such bailing and/or packing system could provide a higher BTU value or enhanced chemical trace elements resulting in the solid fuel generating a greater or prolonged thermal image.

The manufactured solid fuel produces a product that is viable and enhances the efficiency and throughputs of energy generation in the fields of coal, natural gas, syngas, gasification, plasma arc gasification pyrolysis, and pyrolysis gasification. The use of the manufactured solid fuel into these methodologies will produce greater throughputs and economic enhancement, while reducing emissions.

### EXAMPLE 1

Initial manual and mechanical disassembly of the solid wastefeedstock for removal of non-combatable material will be performed based on size and characteristics to ensure maximum BTU and caloric value.

Further separation and mixing will occur by hydraulic methods. Raw material is further agitated to expose the base components/elements of the solid waste raw material.

Material is sorted for primary size, combining agitation by placing the raw material on a vibratory screen, with a sieve of 1 foot minus passing the screen.

Material not passing through the screen will be further mechanically sorted into primary organic and inorganic categories. Organics will undergo a uniform grinding of the raw material through a primary shredding

The organics material will be conveyed to re-incorporate the raw solid waste at the point of initial separation.

Inorganics not passing the initial 1′ primary screen will be resorted for recyclables and non-desirable (hazardous) materials.

Inorganics will be mechanically crushed and optically screened to separate ferrous and non-ferrous metals from beneficial organics.

The reconstituted 1′ minus raw material will then be further sorted by mechanical and manual methods. The introduction of eddy currents and magnets will provide a further refinement and removal of ferrous and nonferrous material.

Final initial separations of organics and inorganics are optically performed to create two process streams for further refinement of the organics and inorganics.

The inorganic waste stream passes through an automated controller using sensors to further distinguish the base organics respectively based on their chemical compound and molecular structure.

The organic waste stream is conveyed through a process of optically removing the lowest carbon organics, which may be further reintroduced as a means of reducing BTU values or chemical composition of the solid fuel.

Centrifugal separation of the initial moisture content of the organics stream is introduced to the organic stream after optical separation. The centrifuge duration will be calculated on the initial percentage of moisture of the RSPV to dry weight. Time and speed will be, maximized to induce separation of moisture in the organics current state.

Pressing may be added to lower the moisture-content as a percentage of moisture to dry weight. The methodology will be incorporated after optimum analysis of the organics when compared to the desired caloric value of the base organic solid fuel as a means of reducing particle size and physical characteristics.

The addition of shredding is added to the organic process to accomplish further reduction in particle size. This process is accomplished while the elements of the base in organic are still separated by elemental chemical category.

The addition of grinding after moisture reduction will be dependent of the minimum/maximum value of the chemical elements desired for the base solid fuel mixture. Further grinding to reduce particle size will be dependent on the variation of the initial composition of the MSW for the production duration, and the desired combination of the BTU value and chemical composition.

Drying and microwave may be incorporated as a means of inducing dehydration of the organic waste stream to ensure a value that is compatible to the achievable BTU requirements. Heat may be used as the means of drying for dehydration with a range of 125 degrees to 500 degrees.

In certain instances, microwave may be used to not only induce drying, but to molecularly change certain organic sugars and fat contents.

In certain instances heat/microwave may be, introduced to the inorganics, as the means of drying and may/or may not be used in conjunction with centrifugal methods. The introduction of heat will be of a temperature range of 125 degrees to 500 degrees, dependent on the moisture content of established in the inorganics.

Heat duration and specific methodology will vary dependent on the molecule structure and the moisture of the base chemical feedstock. Duration of the process will be variable depending on the final resultant of the solid fuel, and will range from 15 seconds to a maximum of 85 seconds.

The addition of microwave may be added as a method of initiating dehydration, of organic's to alter the molecular structure of the organics to ensure chemical association or disassociation of the solid fuel gas produced. Duration of the microwave process, as well as the power will be variable dependant on the base mix design and the composition of the initial raw RSW material.

The inorganics upon completion of the drying and/or at the stage of shredding are recombined by a percentage of weight ratio and base chemical compounds, and caloric value. The process is regulated by the base mix requirements for BTU value and range of specific chemical gases required as a minimum/maximum value of the solid fuel.

Dependent on the variation of the initial raw material received and the composition, excess inorganics that are not incorporated into the current production solid fuel being produced will convey to a storage area where they can be incorporated later to supplement the composition as a percentage of weight of the raw material, or BTU value and chemical structure.

Organics upon completion of the drying process are mixed in a minimum first process to ensure a minimum 60% uniformity, of the organic base mix. The process of horizontal or vertical mixture may be incorporated to remove the entrapment of air. The speed and duration of mixing will be based on the final density of the organics as a percentage of volume to weight.

The inorganics are then entered into a mechanical mixing method ensuring uniformity and a minimum of 60% integration of the inorganics mix prior to reentering the production process.

Organics and inorganics are combined into a mixing process to reconstitute the production fuel mix. The percentage of organics and inorganics are electronically measured for density as a percentage of total weight and volume, with random sampling of a minimum of 5% to a maximum of 50% dependent on solid fuel base design.

The mix is subject to an analysis of its BTU value, but also its chemical compounds. This data is incorporated into thermo-dynamic modeling which establishes the baseline boiler efficiency, and reflects expected emissions.

The solids fuel base mix is introduced into a compaction process that hydraulically will reduce volume by varying ratios dependent on initial density upon entering the compaction.

Further compaction on both the horizontal and vertical access may be introduced as a single or combined access method.

The solid fuel will be further placed in a mechanical permeation and encapsulation process where the fuel will be treated with a low viscosity, binding agent that can be organic or in organic. Additionally, heat may by introduced to the encapsulation process to accelerate binding and to ensure a solid mass is accomplished.

The application of pressure during the injection of the binding agent will ensure stabilization of the fuel mass and a minimum/maximum range of entrapped oxygen in the fuel.

The fuel will be conveyed to a storage area were final curing and storage of the solid fuel product. The fuel may be stored in an environment that will accelerate curing thru the addition of temperature and air circulation.

### EXAMPLE 2

A solid fuel was produced using methods in accordance with the instant invention. The desired analysis of the solid fuel is outlined in Table 2.

TABLE 2
FUEL COMPOSITION BTU/RANGE 10,500-14,500
DESIRED ULTIMATE ANALYSIS ON DRY BASIS:

| | |
|---|---|
| ASH | <4.0% |
| C | 68% < 6.8% |
| H | 8.1% |
| O | <16.0% |
| N | 1.0% |
| S | <1.0% |
| CL | <.1% |
| FL | <.004% |
| H2O | 5.0% |
| HG | <.3 PPM |

Based on a average 5.0% moisture content

Examples of the actual analysis of the solid fuel can be seen in Table 1.

TABLE 1
SAMPLE IDENTIFICATION
MUNICIPAL WASTE
DATE REPORTED: 03/26/10

| | % | % | % | % FIXED | BTU/ | % |
|---|---|---|---|---|---|---|
| | MOISTURE | ASH | VOLATILE | CARBON | LBS | SULFUR |
| AS REC'D | 0.88 | 2.14 | 91.08 | 5.90 | 12683 | 0.07 |
| DRY BASIS | — | 2.16 | 91.89 | 5.95 | 12796 | 0.07 |
| M-A-FREE | | | | | 13078 | |

Note: Sample Tested using ASTM Volume 05.06 for Gaseous Fuels;
Coal and Coke

ULTIMATE ANALYSIS

| | (% DRY BASIS) |
|---|---|
| ASH | 2.16 |
| HYDROGEN | 7.54 |
| CARBON | 66.41 |
| NITROGEN | 0.61 |
| SULFUR | 0.07 |
| OXYGEN | 23.21 |
| CHLORINE | 0.41 |

As shown in Table 1, solid fuel produced in accordance with the instant invention surpasses desired dry analysis targets.

### EXAMPLE 3

Additional samples of solid fuel were produced in accordance with the methods described herein. The analysis of these samples is shown in Tables 3 and 4.

TABLE 3

| | | | | | | Weight % | |
|---|---|---|---|---|---|---|---|
| | | As | Dry | | | As | Dry |
| PROXIMATE ANALYSIS | | Received | Basis | ULTIMATE ANALYSIS | | Received | Basis |
| % Moisture | D3302 | 2.17 | ***** | % Moisture | D3302 | 2.17 | ***** |
| % Ash | D3174 | 4.41 | 4.51 | % Carbon | D5373 | 65.89 | 67.35 |
| % Volatile | D3175 | 92.28 | 94.33 | % Hydrogen | D5373 | 8.12 | 8.30 |
| % Fixed Carbon | D3172 | 1.13 | 1.16 | % Nitrogen | D5373 | 1.91 | 1.95 |
| BTU | D5865 | 13483 | 13782 | % Chlorine | D6721 | 0.15 | 0.15 |
| MAF-BTU | D3180 | 14433 | | % Sulfur | D4239B | 0.05 | 0.05 |
| % Total Sulfur | D4239B | 0.05 | 0.05 | % Ash | D3174 | 4.41 | 4.51 |
| SULFUR FORMS | | | | % Oxygen (Diff.) | D3176 | 17.30 | 17.69 |
| % Pyritic | D2492 | ***** | ***** | (Chlorine D6721 Dry Basis ug/g 1471) | | | |
| % Sulfate | D2492 | ***** | ***** | MINERAL ANALYSIS | D6349 | % Ignited | Basis |
| % Organic | D2492 | ***** | ***** | Phos. Pentoxide, | P2O5 | | ***** |
| % Total Sulfur | D4239B | 0.05 | 0.05 | Silica, | SiO2 | | ***** |
| WATER SOLUBLE | | | | Ferric Oxide, | Fe2O3 | | ***** |
| % Na2O | ASME1974 | ***** | ***** | Alumina, | Al2O3 | | ***** |
| % K2O | ASME1974 | ***** | ***** | Titania, | TiO2 | | ***** |
| % Chlorine | ASME1974 | ***** | ***** | Lime, | CaO | | ***** |
| Alkalies as Na2O | ASME1974 | ***** | ***** | Magnesia, | MgO | | ***** |
| FUSION TEMP. OF ASH D1857 | | Reducing | Oxidizing | Sulfur Trioxide, | SO3 | | ***** |
| I.D. | | ***** | ***** | Potassium Oxide, | K2O | | ***** |
| H = W | | ***** | ***** | Sodium Oxide, | Na2O | | ***** |
| H = ½ W | | ***** | ***** | Barium Oxide, | BaO | | ***** |
| Fluid | | ***** | ***** | Strontium Oxide, | SrO | | ***** |

| GRINDABILITY INDEX D409 | ***** @ ***** | % Moist. | Manganese Dioxide, | MnO2 | ***** |
|---|---|---|---|---|---|
| GRIND INDEX UNCONDITIONED | ***** @ ***** | % Moist. | Undetermined | | ***** |
| FREE SWELLING INDEX D720 | ***** | | Type of Ash | ASME1974 | ***** |
| Apparent Specific Gravity of Coal ModIC7113 | | ***** | Silica Value | ASME1974 | ***** |
| % Equilibrium Moisture D1412 | ***** | | T250 Deg | B&W | ***** |

| | | |
|---|---|---|
| Base/Acid Ratio | ASME1974 | ***** |
| lb Ash/mm | BTU | 3.27 |
| lb SO2/mm | BTU | 0.07 |
| Fouling Index | ASME1974 | ***** |
| Slagging Index | ASME1974 | ***** |

(Mercury D6722 Dry Basis ug/g 0.019)

TABLE 4

| | | | | | | Weight % | |
|---|---|---|---|---|---|---|---|
| | | As | Dry | | | As | Dry |
| PROXIMATE ANALYSIS | | Received | Basis | ULTIMATE ANALYSIS | | Received | Basis |
| % Moisture | D3302 | 2.12 | ***** | % Moisture | D3302 | 2.12 | ***** |
| % Ash | D3174 | 2.30 | 2.35 | % Carbon | D5373 | 66.91 | 68.36 |
| % Volatile | D3175 | 94.15 | 96.19 | % Hydrogen | D5373 | 8.31 | 8.49 |
| % Fixed Carbon | D3172 | 1.43 | 1.46 | % Nitrogen | D5373 | 2.30 | 2.35 |
| BTO | D5865 | 13652 | 13948 | % Chlorine | D6721 | 0.15 | 0.15 |
| MAF-BTU | D3180 | 14284 | | % Sulfur | D4239B | 0.03 | 0.03 |
| % Total Sulfur | D4239B | 0.03 | 0.03 | % Ash | D3174 | 2.30 | 2.35 |
| SULFUR FORMS | | | | % Oxygen (Diff.) | D3176 | 17.88 | 18.27 |
| % Pyritic | D2492 | ***** | ***** | (Chlorine D6721 Dry Basis ug/g 1486) | | | |
| % Sulfate | D2492 | ***** | ***** | MINERAL ANALYSIS | D6349 | % Ignited | Basis |
| % Organic | D2492 | ***** | ***** | Phos. Pentoxide, | P2O5 | | ***** |
| % Total Sulfur | D4239B | 0.03 | 0.03 | Silica, | SiO2 | | ***** |
| WATER SOLUBLE | | | | Ferric Oxide, | Fe2O3 | | ***** |
| % Na2O | ASME1974 | ***** | ***** | Alumina, | Al2O3 | | ***** |
| % K2O | ASME1974 | ***** | ***** | Titania, | TiO2 | | ***** |
| % Chlorine | ASME1974 | ***** | ***** | Lime, | CaO | | ***** |
| Alkalies as Na2O | ASME1974 | ***** | ***** | Magnesia, | MgO | | ***** |
| FUSION TEMP. OF ASH D1857 | | Reducing | Oxidizing | Sulfur Trioxide, | SO3 | | ***** |
| I.D. | | ***** | ***** | Potassium Oxide, | K2O | | ***** |
| H = W | | ***** | ***** | Sodium Oxide, | Na2O | | ***** |
| H = ½ W | | ***** | ***** | Barium Oxide, | BaO | | ***** |
| Fluid | | ***** | ***** | Strontium Oxide, | Sro | | ***** |

| GRINDABILITY INDEX D409 | ***** @ ***** | % Moist. | Manganese Dioxide, | MnO2 | ***** |
|---|---|---|---|---|---|
| GRIND INDEX UNCONDITIONED | ***** @ ***** | % Moist. | Undetermined | | ***** |
| FREE SWELLING INDEX D720 | ***** | | Type of Ash | ASME1974 | ***** |
| Apparent Specific Gravity of Coal ModIC7113 | | ***** | Silica Value | ASME1974 | ***** |
| % Equilibrium Moisture D1412 | ***** | | T250 Deg | B&W | ***** |

| | | |
|---|---|---|
| Base/Acid Ratio | ASME1974 | ***** |
| lb Ash/mm | BTU | 1.68 |
| lb SO2/mm | BTU | 0.04 |
| Fouling Index | ASME1974 | ***** |
| Slagging Index | ASME1974 | ***** |

(Mercury D6722 Dry Basis ug/g 0.015)

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A systems for making solid fuels from various waste compositions comprising:
pre-sorting equipment to segregate useable recyclable materials;
equipment to reduce Material size;
mixing equipment; and
packing equipment.

2. The system of claim 1, further comprising:
separating equipment to separate organic from inorganic material.

3. The system of claim 1, further comprising drying equipment.

4. The system of claim 1, further comprising optical sensors and controllers to asses the physical characteristics of the solid fuel.

5. A method for making solid fuel from waste compositions comprising the steps of:
determining a desired BTU value;
obtaining waste composition;
sorting and removing useable recyclable material from the waste composition;
assessing the physical characteristics of the waste composition to determine BTU value; and
supplementing the waste composition with compounds to adjust the BTU value of the waste composition to the desired BTU value, thereby producing a solid fuel with the desired BTU value.

6. The method of claim 5, further comprising the step of drying the waste composition.
